(19) United States
(12) Patent Application Publication
(10) Pub. No.: US 2017/0225910 A1
(43) Pub. Date: Aug. 10, 2017

(54) METHOD AND APPARATUS FOR HANDLING MATERIAL IN A PNEUMATIC PIPE TRANSPORT SYSTEM

(71) Applicant: Göran SUNDHOLM, Tuusula (FI)

(72) Inventor: Göran SUNDHOLM, Tuusula (FI)

(73) Assignee: MARICAP OY, Vantaa (FI)

(21) Appl. No.: 14/344,727

(22) PCT Filed: Sep. 11, 2012
(86) PCT No.: PCT/FI2012/050879

§ 371 Date: Mar. 13, 2014

(30) Foreign Application Priority Data
Sep. 14, 2011 (FI) 20115900

(51) Int. Cl. B65G 53/46; B65G 53/60; B65G 53/24

(52) U.S. Cl. CPC B65G 53/4691; B65G 53/24; B65G 53/60

(57) ABSTRACT

Method for handling waste material in a pneumatic pipe transport system, wherein waste material is fed in from an input point into conveying piping, and conveyed in the conveying piping, mainly by the aid of suction/a pressure difference and/or a flow of transporting air, onwards to a separating device (1), in which the waste material to be transported and the transporting air separate from each other, from which separating device the waste material is transferred onwards to a separate waste container (26). Waste material is transferred, or is transferred and compressed to become denser, from the separating device (1) into a separate waste container (26) in a connecting channel (9) arranged between them with a transfer member (10) from the input aperture (8) of the connecting channel towards the output aperture (9′) and onwards into a separate waste container (26), and in which method the connection from the separating device (1) to the connecting channel (9) is closed at least during the detachment of the waste container (26). The invention also relates to an apparatus.

### BACKGROUND OF THE INVENTION

The object of the invention is a method as defined in the preamble of claim 1.

The object of the invention is also an apparatus as defined in the preamble of claim 13.

The invention relates generally to material conveying systems, such as to partial-vacuum conveying systems, more particularly to the collection and conveying of wastes, such as to the conveying of household wastes.

Systems wherein wastes are conveyed in piping by means of a pressure difference or suction are known in the art. In these, wastes are conveyed long distances in the piping by sucking. It is typical to these systems that a partial-vacuum apparatus is used to achieve a pressure difference, in which apparatus a partial vacuum is achieved in the conveying pipe with partial-vacuum generators, such as with vacuum pumps or with an ejector apparatus. A conveying pipe typically comprises at least one valve means, by opening and closing which the replacement air coming into the conveying pipe is regulated. Input points, such as refuse chutes, are used in the systems at the material input end, into which input points material, such as waste material, is input and from which the material to be conveyed is conveyed into a conveying pipe by opening a discharge valve means. The conveying of wastes occurs mainly by the aid of an air flow produced by a pressure difference. The air flow is generally brought about by sucking air through the piping. Waste material, such as e.g. waste material packed into bags, is conveyed from an input point into a conveying pipe and onwards into a separating device, where the wastes are separated from the transporting air. In connection with the separating device can be a transfer device, such as a transfer device arranged on a cylinder-piston combination, with which transfer device the wastes are transferred from the separating device into a waste container, e.g. into a freight container.

The aim of the present invention is to achieve an entirely new type of solution for a transfer device in a pneumatic wastes conveying system, more particularly between a separating device and a waste container, by the aid of which transfer device the drawbacks of prior-art solutions are avoided. One aim of the invention is to achieve a method and a transfer device having reliable operation, advantageous transfer distance and good capacity for the application target. On the other hand, one aim is achieve a method and a transfer device wherein a separate waste container can be removed/replaced from being in connection with the transfer device even though the waste conveying system, such as piping and a separating device, are in operation. In this case typically a partial vacuum prevails in the piping and in the separating device.

### BRIEF DESCRIPTION OF THE INVENTION

The method according to the invention is mainly characterized by what is stated in the characterization part of claim 1.

The method according to the invention is also characterized by what is stated in claims 2-12.

The apparatus according to the invention is mainly characterized by what is stated in the characterization part of claim 13.

The apparatus according to the invention is also characterized by what is stated in claims 14-22.

The solution according to the invention has a number of important advantages. With the arrangement according to the invention it is possible to keep a waste conveying system in operation, such as having a continuous partial vacuum in the piping and in the separating device, also when a separate waste container is being replaced. By arranging a transfer member, comprising a double-action or at least a double-phase actuator i.e. a drive device with at least two operating states, in the connecting channel between the separating device and the transferable waste container, with which transfer member on the one hand effective transfer capability and a long transfer capacity is achieved, a drive apparatus of a shut-off means can be simultaneously achieved. According to the invention, the apparatus can also be used to cut possible material pieces causing a blockage and thus clear and prevent/reduce clogging of the apparatus. By using two drive means, such as cylinder-piston units, as actuators of a drive device, effective operation of the transfer member is achieved and sufficient operating distance and transfer capacity is obtained. The solution according to the invention shortens the stroke length of an individual drive means, such as of a cylinder-piston unit. At the same time the space requirement can be reduced. In addition, the drive apparatus can be effectively utilized simultaneously as a drive device of a shut-off means. By connecting a first drive means, such as a cylinder-piston unit, by the aid of a coupling part to a second drive means, such as a cylinder-piston unit, and for moving along with the movement of it, a sufficient operating distance and effective transfer capacity can be achieved, in which case at the same time versatile drive possibilities of the drive means are enabled. With the solution according to the invention, the transfer member can be moved with a second drive means, such as with a cylinder-piston unit, more frequently and with the first drive means, such as with a cylinder-piston unit, only at intervals, i.e. typically less frequently. By using a differential switch in the control of the drive means, energy can be saved. Alternatively, faster action of the drive means is achieved. With the control of the drive means very versatile operation of the apparatus is achieved.

With the solution according to the invention a highly effective and multipurpose transfer device is achieved in connection with pneumatic waste conveying systems, more particularly in applications in which waste is conveyed from a separating device into a separate waste container detachable from the system.

### BRIEF DESCRIPTION OF THE FIGURES

In the following, the invention will be described in more detail by the aid of an embodiment with reference to the attached drawings, wherein

FIG. 1 presents a simplified and partially cross-sectioned view of an embodiment of an apparatus according to the invention,

FIG. 2 presents a simplified view of a part of an embodiment of an apparatus according to the invention in a first position,

FIG. 3 presents a simplified view of a part of an embodiment of an apparatus according to the invention in a second position,

FIG. 4 presents a simplified view of a part of an embodiment of an apparatus according to the invention in a third position,

FIG. 5 presents a simplified view of a part of an embodiment of an apparatus according to the invention in a first phase of a second operating state,

FIG. 6 presents a simplified view of a part of an embodiment of an apparatus according to the invention in a second phase of the second operating state,

FIG. 7 presents a simplified view of a part of an embodiment of an apparatus according to the invention in a third phase of the second operating state,

FIG. 8 presents a simplified view of a part of an embodiment of an apparatus according to the invention in a fourth phase of the second operating state,

FIG. 9 presents a simplified view of a part of an embodiment of an apparatus according to the invention in a fifth phase of the second operating state,

FIG. 10 presents a simplified view of a part of an embodiment of an apparatus according to the invention in a first position,

FIG. 11 presents a simplified view of a part of an embodiment of an apparatus according to the invention in a blocked state,

FIG. 12 presents a simplified view of a part of an embodiment of an apparatus according to the invention in a third operating state,

FIG. 13 presents a hydraulic diagram of the drive means of an apparatus according to the invention, and

FIGS. 14(a)-(h) present some operating states of the drive means of an apparatus according to the invention as a diagram in different operating states.

### DETAILED DESCRIPTION OF THE INVENTION

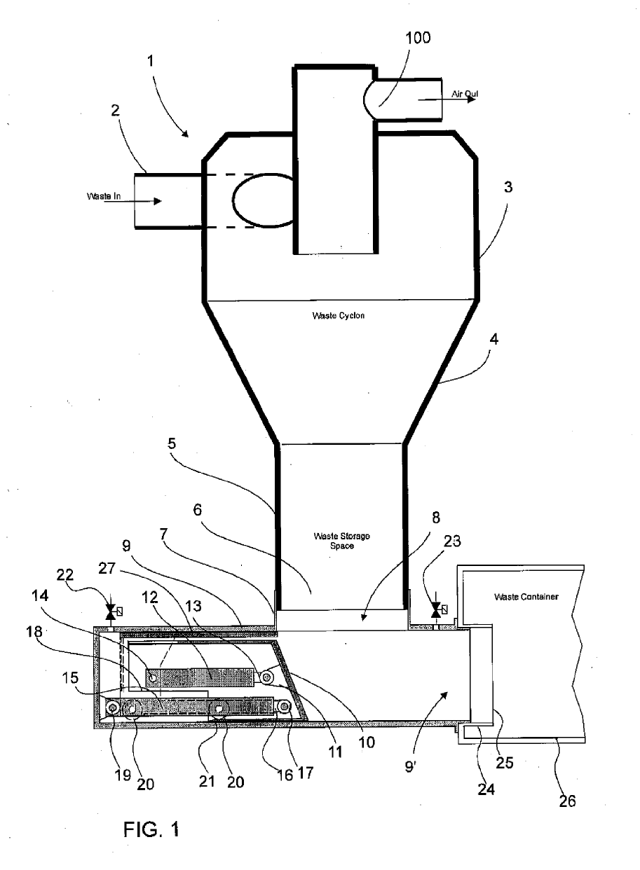

FIG. 1 presents one embodiment of the solution according to the invention, wherein a press apparatus/compactor apparatus is arranged in connection with a separating device 1 of a pneumatic wastes handling system, which apparatus comprises a transfer member 10 and its drive apparatus. The separating device 1 comprises a storage part 3, to which an inlet pipe 2 is connected, which inlet pipe is connected to the conveying piping (not presented) for wastes and which can be connected to input points (not presented). Material, such as household waste is fed in an input point into the piping, where it is conveyed by the aid of suction/a pressure difference and/or transporting air flowing in the piping into the storage part 3 of the separating device from the inlet pipe 2, in which storage part 3 of the separating device the waste material is separated from the transporting air, e.g. by the aid of gravity and/or centrifugal force, such that heavier material finds its way to the bottom part 5 of the separating device. An outlet pipe 100 is arranged in the top part of the separating device, which outlet pipe is connected to the suction side of a partial-vacuum generator, such as of an ejector pump or fan. The transporting air leaves the storage part 3 of the separating device into the outlet pipe 100.

The storage part 3 of the separating device 1 comprises, in the embodiment of the figure, a section 4 tapering conically towards the bottom part. In the embodiment of FIG. 1, a cylindrical section, having an output aperture 6 for material in its bottom part, is arranged in the bottom part 5 of the storage part 3 of the separating device after the conical section 4. Material can thus leave the storage part 3 via the output aperture 6 formed in its bottom part 5.

A connecting channel 9 between the output aperture 6 for material of the storage part 3 of the separating device and the input aperture 25 of a separate waste container 26 is arranged in connection with the separating device 1, which connecting channel comprises an input aperture 8, which is arranged face-to-face with the output aperture 6 of the storage part 3 of the separating device and the connecting channel 9 has an output aperture 9′, which can be arranged face-to-face with the input aperture 25 of the separate waste container 26. The connecting channel 9 is connected to the bottom part 5 of the storage part 3 of the separating device with a collar part 7.

A transfer member 10 is arranged in the connecting channel 9 so as to move between at least two positions. The transfer member is arranged to transfer waste material, which is conducted from the input aperture 8 into the connecting channel 9, in the connecting channel towards its output aperture 9′ and onwards into a separate waste container 26 from the input aperture 25, or at least to the proximity of the input aperture 25. The transfer member can, in connection with the transfer, simultaneously also compress the waste to be transferred to be denser, i.e. to compact the waste into the separate waste container 26.

FIGS. 1-4 present a first operating state of the transfer member 10 of the separating device, in which the material, more particularly waste material, is mainly transferred from the storage part 3 of the separating device via the connecting channel 9 with the transfer member 10 into a separate waste container 26.

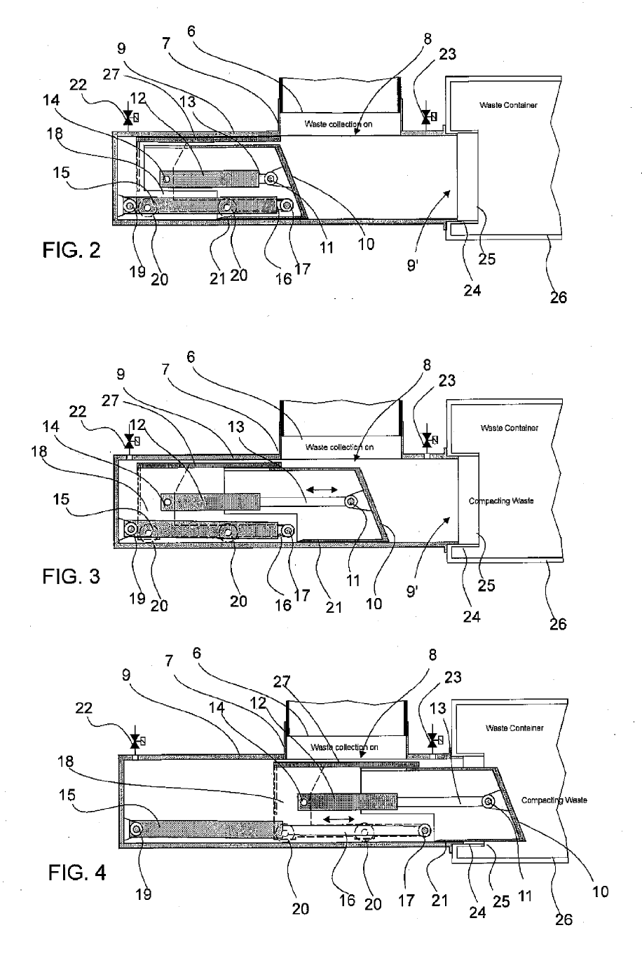

In the first position (which is presented in FIGS. 1 and 2) of the transfer member 10 it is in a position in which waste material is able to be transferred from the container 3 into the connecting channel 9. A drive apparatus 12, 13, 15, 16 is arranged to move the transfer member 10. The drive apparatus comprises, in the embodiment of the figures, two drive means 12, 13; 15, 16, e.g. a cylinder-piston combination. The first drive means 12, 13 is at its first end arranged onto the transfer member 10 with fixing means 11 and at its second end onto the coupling part 18 with fixing means 14. The coupling part 18 is in turn fixed to a first end 17 of the second drive means 15, 16, i.e. to the moving end, and the second end of the second drive means 15, 16 is arranged onto a support part 19 with fixing means. The support part 19 is, in the embodiment of the figure, fixed to the wall of the connecting channel 9, in the figure to the butt end wall.

The transfer member 10 is arranged to be moved such that it can be transferred to and fro in the connecting channel 9 with the drive device. According to one preferred embodiment the transfer member 10 can be moved such that at first the transfer member is moved from a first position (FIG. 2) into a second position (FIG. 3), which is only a part of the movement scope of the transfer member in the connecting channel 9. In this case the connection between the output aperture 6 of the separating device and the input aperture 8 of the connecting channel can be kept at least partly open at least for a part of the duration of movement of the transfer member 10. The transfer member 10 can be moved to and fro between the first and the second position. This is described in FIG. 3 with an arrow. In this case waste material can be transferred quickly from the input aperture 8 via the connecting channel 9 into the output aperture 9′. The transfer member 10 is thus used to transfer material via the output aperture 9′ into a separate waste container and maybe also to compress the material to be transferred to become denser.

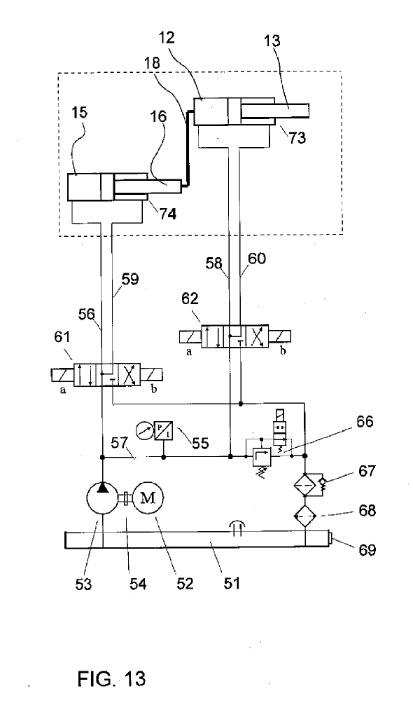

The drive means, such as a piston-cylinder combination, is typically operated by a spring, is hydraulically operated, or is operated by gas, or is operated by a combination of these. The drive means can also be some other corresponding component bringing about a movement. In the embodiments of the figures a hydraulic drive apparatus is used. For clarifying the operation of the hydraulic drive apparatus, a hydraulic diagram is also presented in FIG. 13.

The transfer member 10 also has, according to FIG. 4, at least one third position, in which the second drive means 15, 16 has transferred the first drive means 12, 13 and the transfer member 10 in the connecting channel 9 towards the output aperture 9′ (in FIGS. 3 and 4 to the right). In the figure the transfer member extends through the output aperture 9′ into the separate waste container 26 from the input aperture 25 of the waste container.

By moving the transfer member 10 in the connecting channel 9 from a first or second position into a third position, it can be ensured that the waste material to be transferred transfers from the connecting channel 9 into the waste container 26. In addition the waste material can simultaneously be compressed to become denser, preferably in the connecting channel 9 and in the separate waste container 26.

In the embodiment of the figures a shut-off means 27 of the input aperture 8 of the connecting channel 9 is arranged on the coupling part 18 for moving along with it. According to FIG. 4, a plate-like shut-off means 27, which rests in the situation of

FIG. 4 on the top part of the transfer member 10 as well as on the coupling part, is arranged on the top part of the coupling part 18. The shut-off means 27 and/or the transfer member 10 can move in relation to each other, e.g. in a situation in which the transfer member has stopped e.g. owing to a blockage (FIGS. 11 and 12). The edge 28 (FIG. 11, 12) of the shut-off means 27 can be used to cut a possible obstructing object and to clear a blockage. According to FIG. 4 there is a small clearance between the shut-off means 27 and the input aperture 8 of the connecting channel 9. With the coupling part 18 the first drive means 12, 13 and the second drive means 15, 16 can, in the retracted position, i.e. the initial position (FIG. 2), be configured to suitable distances in relation to each other. Also the shut-off means 27 can be configured to a suitable location point in relation to the coupling part 18 with respect to the movement of the drive means 12, 13; 15, 16 and to the length of the connecting channel 9 and to the location of the input aperture 8.

For facilitating the moving of the shut-off means 27 and/or the transfer member 10, at least one support roller 20 is arranged on the drive device or on the coupling part 18. In the embodiment of the figures there are two support rollers 20. The support rollers can rest on the wall, more particularly the bottom wall, of the channel 9.

A support part 21 is arranged for the transfer member 10, which support part forms an elevation extending from the bottom wall of the channel 9 inwards into the channel, upon which a support roller 20 can be placed in the first or second position of the first operating state, when the second drive means 15, 16 is in the retracted position.

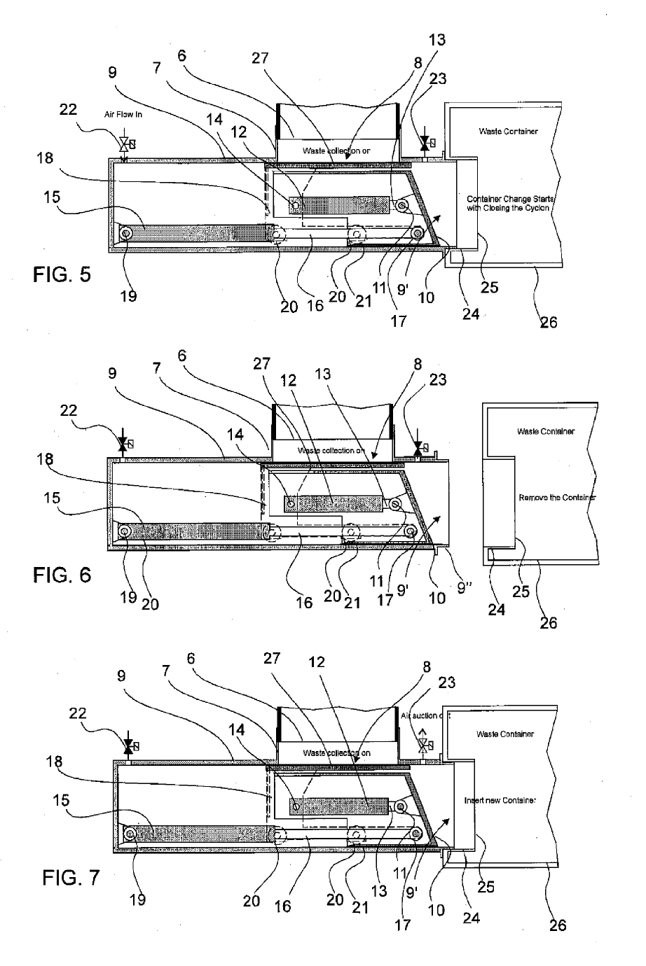

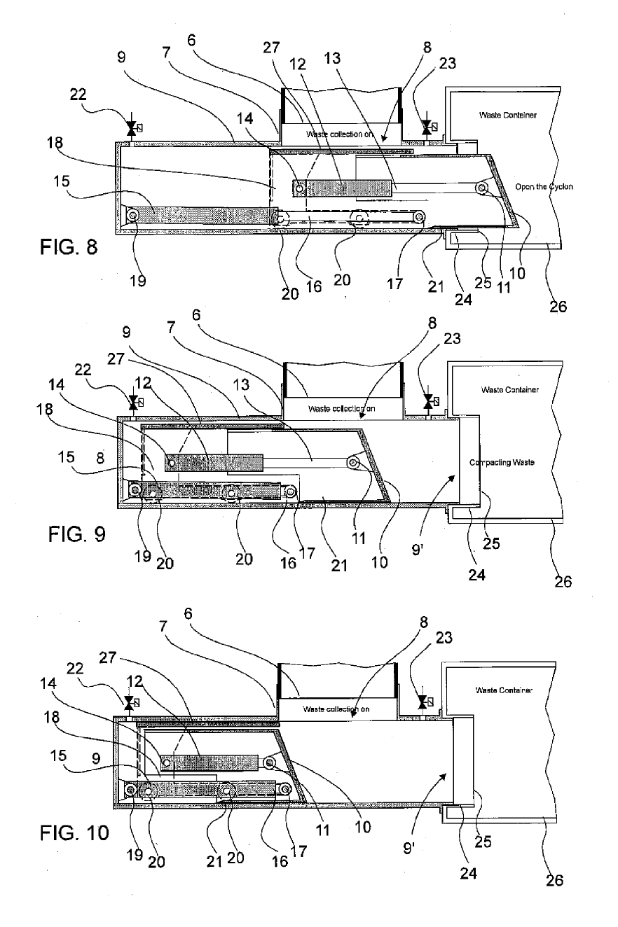

FIGS. 5-10 present the different phases of the second operating state of the transfer member 10 of the separating device. In the second operating state the aim is to close the connection via the connecting channel 9 from the storage space 3 of the separating device to the separate waste container 26 and also to prepare for detachment of the separate waste container 26 from the connection with connecting channel 9 and with the separating device for emptying the separate waste container and also to bring an empty separate waste container 26 and connect it into connection with the separating device via the connecting channel 9.

FIG. 5 presents a situation in which there is a partial vacuum on the inlet side of the input aperture 8 of the connecting channel, i.e. on the side of the storage space (not presented in FIGS. 2-10) of the separating device with respect to the shut-off means 27 (above in the situation of FIG. 5). An input air branch coupling 22 provided with a valve means is formed in the connecting channel on the opposite side of the transfer member 10 with respect to the output aperture 9′ of the connecting channel. When the input air branch coupling 22 is opened, the shut-off means 27 shifts essentially against the areas of the wall of the connecting channel 9 around the edges of the input aperture 8 of the connecting channel, owing to the partial vacuum prevailing on the separating device side of the shut-off means. When the air is brought from the input air branch coupling 22, waste particles that have possibly remained in the connecting channel are simultaneously displaced into the separate waste container 26 owing to the air flow. Essentially atmospheric pressure forms in the connecting channel 9 and the separate waste container 26 can be detached from connection with the connecting channel 9, even if there is a partial vacuum in the storage part of the separating device and the separating device is in operation. This detachment phase of a separate waste container 26 is presented in FIG. 6. When the waste container is connected into connection with the output aperture 9′ of the connecting channel, the input air branch coupling 22 can be closed.

FIG. 7 presents the connection of the input aperture 25 of the separate waste container 26 in connection with the output aperture 9′ of the connecting channel 9.

At the output aperture 9′ end of the connecting channel 9 is a section 9″, which extends inside the collar 24 of the input aperture 25 of the separate waste container. Other types of connection arrangements can be used.

An output air branch coupling 23 provided with a valve means is arranged between the input aperture 8 of the connecting channel 9 and the output aperture 9′, from which branch coupling suction can be brought about in the connecting channel 9 and, if necessary, in the separate waste container 26. Via the output air branch coupling 23 the desired partial vacuum is brought about in the connecting channel 9. When sufficient equilibrium is reached on the different sides of the channel closed by the shut-off means, the shut-off means 27 shifts owing to gravity and owing to the fact that the transfer member 10 and the elevated part 21 on the bottom of it shift towards the output aperture 9′, in which case the support roller 20 that is against elevated part 21 shifts against the bottom wall of the connecting channel. In this case the coupling part 8 and the shut-off means 27 are able to move in the figure downwards, in which case a gap forms between the shut-off means 27 and the input aperture of the connecting channel

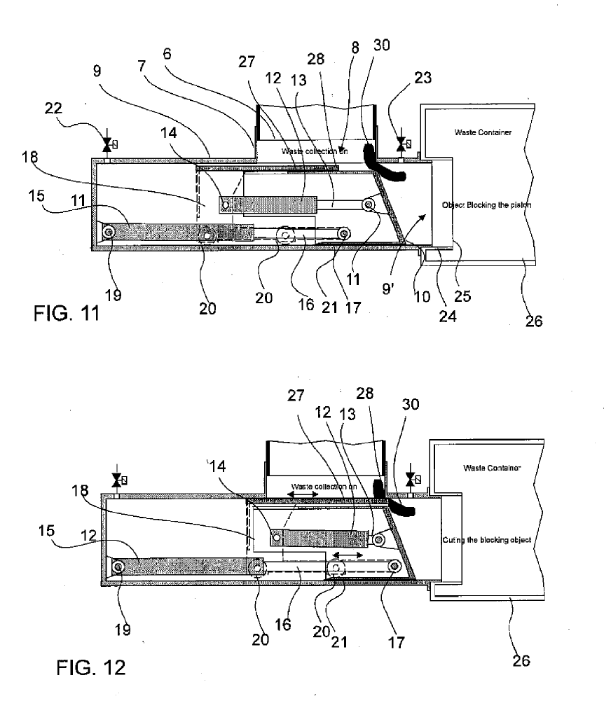

The output air branch coupling 23 can be closed and operation in respect of the transfer member 10 can again be continued. The shut-off means 27 is shifted by the aid of a drive device, preferably with the second drive means 15, 16, such as with a cylinder-piston combination, into the initial position (at first FIG. 9 and then FIG. 10), in which the shut-off means 27 is not at the point of the input aperture 8 of the connecting channel.

When the separate waste container 26 has been replaced it is often advantageous to bring about a partial vacuum in the connecting channel 9 and in the separate waste container before the removal of the shut-off means 27 from in front of the input aperture 8 and the opening of the connection from the storage space 3 of the separating device to the connecting channel 9 and onwards into the separate waste container. In this case the passage of the air flow into the separating device from the direction of the connecting channel can be prevented. A partial vacuum also facilitates the removal of the shut-off means 27 from in front of the input aperture. If the partial vacuum of the separate waste container is greater than in the storage space of the separating device, waste can be transferred, owing to the removal of the shut-off means, momentarily from the separating device into a separate waste container also without movement of the transfer member 10.

FIGS. 9 and 10 further present the transfer of the shut-off means 27 and of the transfer member 10 back into the initial state and the opening of the input aperture 8.

FIGS. 11 and 12 present a third operating state of the apparatus, in which the movement of the transfer member has stopped, e.g. as a result of a blockage, or that a detrimental object 30, such as a waste particle or item, has got between the edge of the input aperture 8 or the wall of the connecting channel and the transfer member 10. In this case the detrimental object 30 can be cut through with the edge 28 of the shut-off means 27. With the edge 28 of the shut-off means a detrimental object can be acted upon with a surface pressure that is considerably greater than that on the transfer member. Typically a surface pressure that is up to 20 times the surface pressure of the transfer member 10 is achieved with the edge 28 of the shut-off means 27.

By using two drive means 12, 13; 15, 16 as actuators of a drive device, effective operation of the transfer member 10 is achieved and sufficient operating distance and transfer capacity is obtained. In addition, the drive apparatus can be effectively utilized simultaneously as a drive device of a shut-off means 27.

With the solution according to the invention a highly effective and multipurpose transfer device is achieved in connection with pneumatic waste conveying systems, more particularly in applications in which waste is transferred from a separating device to a separate waste container detachable from the system.

The first drive means 12, 13 is, in the embodiment of the figures, a cylinder-piston unit, which comprises a cylinder part 12, into which a first piston part 13 is arranged in a sealed manner onto the wall of the cylinder space of the cylinder part. The first piston part 13 is arranged movably in the cylinder space to move between a first position, in which the first piston part 13 is in a retracted position (in FIGS. 1, 2, 6 and 7 the first piston part is in a retracted position) and a second position, in which the first piston part 13 is pushed outwards in the connecting channel, extending at least to a part of the length of the connecting channel in the output direction (in FIGS. 3, 4, 8 and 9 the first piston part is in the pushed out position).

The second drive means 15, 16 is, in the embodiments of the figures, a cylinder-piston unit, and comprises a cylinder part 15, into which a second piston part 16 is arranged in a sealed manner onto the wall of the cylinder space of the cylinder part. The second piston part 16 is arranged movably in the cylinder space to move between a first position, in which the second piston part 16 is in a retracted position (in FIGS. 1, 2, 3 and 9 the second piston part is in a retracted position) and a second position, in which the second piston part 16 is pushed outwards in the connecting channel, extending at least to a part of the length of the connecting channel in the output direction (in FIGS. 4, 5, 6, 7 and 8 the second piston part is in the pushed out position).

In FIG. 13 the following components are marked with reference numbers:

12 Cylinder

13 Piston rod

15 Cylinder

16 Piston rod

18 Coupling means

51 Pressure medium reservoir

52 Motor

53 Hydraulic pump

54 Coupling

55 Pressure sensor and meter

56 Medium pathway

57 Medium pathway (Outlet line)

58 Medium pathway

59 Medium pathway

60 Medium pathway

61 Control valve

62 Control valve

66 Pressure relief unloading valve

67 Filter and dirtiness sensor

68 Pressure medium cooler and temperature sensor

69 Surface height indicator

73 Drive means (Cylinder-piston-unit)

74 Drive means (Cylinder-piston-unit)

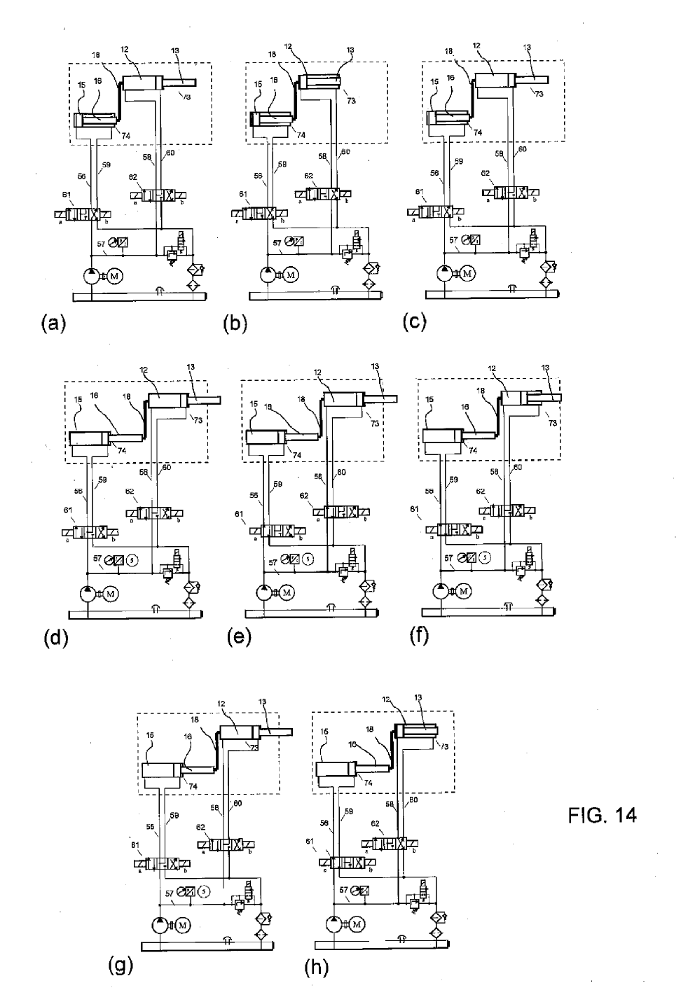

FIG. 13 presents a hydraulic diagram of a drive apparatus according to one embodiment. The drive apparatus comprises means 51, 52, 53, 54, 55, 56, 57, 58, 59, 60 for conducting pressure medium to the drive means 12, 13, 15, 16 of the drive apparatus. The pressure medium is circulated in the circuit with a pump device 53, which is driven with a drive device 52, via a coupling 54. A pressure medium pathway pathway 56, 57, 58, 59, 60 to the drive means 12, 13; 15,16 (in FIGS. 13 and 14: 73, 74) can be connected from the pressure side of the pump device. Two control valves 61, 62, with which the passage of pressure medium to the drive means can be controlled, are arranged in the medium pathways. The control valves 61, 62 are, in the embodiment of the figure, both three-position valves.

The control valves 61, 62 have on the left a position in which when they are in this position pressure medium is conducted to the cylinder space of the drive means, to the piston side, in which case it acts on the drive means on the whole surface area of the piston. In this case the piston rod 13; 16 tries to move outwards, i.e. to the right in the figure. The medium channel on the piston rod side is in this case connected to be a return line to the medium reservoir.

In the control valves 61, 62 the position on the extreme right-hand side is that in which the medium channels are conducted crossways. In this case pressure medium is conducted from the pump to the piston rod side of the drive means, in which case the piston shifts in the figure to the left and the piston rod shifts inwards. The piston side is connected to a return line to the pressure medium reservoir.

The control valves 61, 62 also have a third position, i.e. a center position, the valves in the diagram of FIG. 13 being in this position. In this position the movement of the piston rod can be executed with a so-called differential switch, wherein pressure medium acts on the piston on both sides of it. Since the piston rod side has a smaller area on which the pressure medium acts, the piston tries to shift in the figure to the right and thus to push the piston rod outwards. In this position of the control valve on the one hand energy can be saved or faster movement for the drive means can be achieved. The achievable force is smaller compared to the left-hand position of the control valve in the figure. When the pressure in the medium piping rises to a set value or over it, which is detected with a pressure sensor 55, the control valve can be shifted into the desired position, e.g. into the left-hand position, in which case a greater force is achieved for the drive means. The different operating states are further described in FIGS. 14(a)-(h).

In FIG. 13 the reference number 73 of the first drive means comprises a cylinder-piston unit, comprising a piston rod 13 and a cylinder 12. The second drive means 74 comprises a cylinder-piston unit, the piston rod of which is marked in the figure with the number 16 and the cylinder of which with the number 15. The first and the second drive means are connected to each other with coupling means 18.

FIGS. 14(a)-(h) present for the sake of clarification the positions of the drive means 12, 13; 15, 16; 73, 74 in the different operating states and the positions of the control valves 61, 62 used to control them.

FIG. 14(a) presents a situation in which the control valve 62 of the first drive means 73 is in the center position and the control valve 61 of the second drive means 74 is in a position in which the piston rod 16 of the second drive means has shifted into the retracted position. This corresponds to the position of FIG. 3 or 9.

FIG. 14(b) presents an operating situation, in which the control valve 62 of also the first drive means 73 is in a position in which the piston rod 13 has shifted into the retracted position. This corresponds to the situation of FIGS. 2 and 10.

FIG. 14(c) presents an operating state, which corresponds to the situation of FIGS. 3 and 9, in which there is compression with the first drive means 73, by pushing out the piston rod 13 of it. The control valve 62 is in the center position (the so-called differential position), in which case the force effect brought about by the drive means is roughly the cross-sectional area of the piston rod multiplied by the pressure of the pressure medium. The pressure medium acts in the cylinder space on both sides of the piston, in which case the piston rod side has a smaller surface area and the pressure medium therefore displaces the piston/piston rod outwards.

FIG. 14(d) presents an operating situation, in which the control valve of also the second drive means is in a position in which the rod of its piston shifts outwards into position with a force that corresponds to the cross-sectional area of its piston rod multiplied by the pressure of the pressure medium.

FIG. 14(e) presents an operating situation, in which the control valves of the drive means have shifted into a position in which a force is acting on their piston rods for shifting them outwards, which force is the surface area of the piston times the pressure. The control valve shifts into this position from phase 14(d), if the pressure in the medium pathway, which the pressure sensor 55 measures, rises to the set upper limit or to over it. This can correspond to e.g. the situation of FIG. 4.

FIG. 14(f) presents a situation, which corresponds to the status of FIG. 11, in which the piston rod of the first drive means has stopped e.g. owing to a detrimental object. This phase can follow e.g. the situation of FIG. 14(e), when the pressure has risen to a set upper limit or over it. The control valve of the first drive means switches to the center position, in which case the coupling part 18 is able to move in relation to the stopped piston rod 13 (and to the transfer member 10) of the first drive means. According to FIG. 12 the cutting edge 28 of the shut-off means cuts through the harmful object and elegantly clears the blockage at the same time.

FIGS. 14(g) and (h) present operating states that are used for finally closing the connection from the separating device 1 to the input aperture 8 with the shut-off means 27. This corresponds to the situations of FIGS. 4 and 5.

The invention thus relates to a method for handling waste material in a pneumatic pipe transport system, wherein waste material is fed in from an input point into conveying piping, and conveyed in the conveying piping, mainly by the aid of suction/a pressure difference and/or a flow of transporting air, onwards to a separating device 1, in which the waste material to be transported and the transporting air separate from each other, from which separating device the waste material is transferred onwards to a separate waste container 26. Waste material is transferred, or is transferred and compressed to become denser, from the separating device 1 into a separate waste container 26 in a connecting channel 9 arranged between them with a transfer member 10 from the input aperture 8 of the connecting channel towards the output aperture 9′ and onwards into a separate waste container 26, and in which method the connection from the separating device 1 to the connecting channel 9 is closed at least during the detachment of the waste container 26. According to one embodiment the transfer member is moved with a drive device having at least two operating states.

According to one embodiment the transfer member 10 is moved with a drive device 12, 13, 14, 15, 16, which has at least a first operating state, in which waste material is transferred by moving, with the first drive means 12, 13; 73 of the drive device, the transfer member 10 a part of the distance in the connecting channel 9, at least a second operating state, in which waste material is transferred from the connecting channel 9 into the waste container 26 by moving, moved by the second drive means 15, 16; 74 of the drive device, both the first drive means 12,13, 74 and the transfer member 10, and which has at least a third operating state, in which the connection from the separating device 1 to the connecting channel 9 is closed with the shut-off means 27.

According to one embodiment the shut-off means 27, preferably an edge 28, is used to cut a detrimental object 30 that is in the connecting channel and causing a blockage or preventing movement of the transfer member.

According to one embodiment the shut-off means 27 is moved with a second drive means 15, 16.

According to one embodiment the first drive means 12, 13; 73 is connected with a coupling part 18 to a moving part of the second drive means 15, 16; 74 for moving along with it.

According to one embodiment the shut-off means 27 is brought to be placed against the walls of the chamber 9 in the proximity of the input aperture 8 of the chamber.

According to one embodiment the drive device is supported on the bottom wall of the connecting channel, e.g. with a support roller 20 that reduces friction.

According to one embodiment a partial vacuum is maintained in the separating device 1 and/or the separating device is maintained in operation also during the detachment/replacement of a separate waste container 26.

According to one embodiment the separate waste container 26 is detached from the connection with the connecting channel 9 when the shut-off means 27 is in the closing position.

According to one embodiment in the method an exhaust air duct 23 is opened when a separate waste container 26 is connected to the connecting channel 9, for achieving a partial vacuum in the connecting channel and/or in the separate waste container after connection of the container.

According to one embodiment in the method waste material, more particularly household waste material, is transferred from the separating device via the connecting channel into a separate waste container.

According to one embodiment in the method cylinder-piston units are used as drive means 12, 13; 73; 15, 16; 74, which cylinder-piston units are controlled with control valves 61, 62, with which a differential switch can be selected as one form of use of the drive means.

The invention also relates to an apparatus for handling material in a pneumatic pipe transport system, which comprises at least one input point, conveying piping and also means for conveying material in the conveying piping, mainly by the aid of suction/a pressure difference and/or a flow of transporting air, to a separating device, where the material to be transported is separated from the transporting air, and also a separate waste container and means 10, 12, 13, 15, 16 for transferring waste material that has accumulated in the separating device 1 from the separating device into the waste container 26. The apparatus comprises a connecting channel 9 arranged between the separating device 1 and the separate waste container 26, in which connecting channel a transfer member 10 and a drive device 12, 13, 14, 15, 16 is arranged for moving the transfer member 10 between at least two positions, and that the apparatus comprises a shut-off means 27 for closing the connection from the separating device 1 to the connecting channel 9 at least during the detachment of the waste container 26. According to one embodiment the drive device is having at least two operation states.

According to one embodiment the drive device 12, 13, 14, 15, 16 has a first operating state, in which the transfer member 10 is arranged to be moved with the first drive means 12, 13; 73 of the drive device a part of the distance in the connecting channel 9, a second operating state, in which the second drive means 15, 16; 74 of the drive device is arranged to transfer the first drive means 12,13; 73 and the transfer member 10, and at least one third operating state, in which the shut-off means 27 is arranged to close the connection from the separating device 1 to the connecting channel 9.

According to one embodiment the shut-off means 27, preferably an edge 28, is configured to function as a cutting means for cutting a detrimental object 30 having an effect in the connecting channel 9.

According to one embodiment the shut-off means 27 is configured to be moved with a second drive means 15, 16; 74.

According to one embodiment the first drive means 12, 13; 73 is connected with a coupling part 18 to a moving part of the second drive means 15, 16; 74 for moving along with it.

According to one embodiment the shut-off means 27 is arranged on the coupling part 18 for moving along with it.

According to one embodiment the apparatus comprises means for placing the shut-off means 27 against the walls of the connecting channel 9 in the proximity of the input aperture 8 of the connecting channel.

According to one embodiment a means that reduces friction, e.g. a support roller 20, is arranged on the drive device.

According to one embodiment an exhaust air duct 23 is arranged in the connecting channel, for achieving a partial vacuum in the connecting channel 9 after connection of the waste container 26.

According to one embodiment the first drive means 12, 13; 73 and/or the second drive means 15, 16; 74 is a cylinder-piston unit, which cylinder-piston units are controlled with control valves 61, 62, with which a differential switch can be selected as one form of use of the drive means.

Typically the material is waste material, such as waste material arranged in bags. A refuse chute can be fitted to be a part of a pneumatic waste conveying system or it can be a separate part, in which waste material is conducted into the waste room, waste container or corresponding.

It is obvious to the person skilled in the art that the invention is not limited to the embodiments presented above, but that it can be varied within the scope of the claims presented below. The characteristic features possibly presented in the description in conjunction with other characteristic features can also, if necessary, be used separately to each other.

1. Method for handling waste material in a pneumatic pipe transfer system, wherein waste material is fed in from an input point into conveying piping, and conveyed in the conveying piping, mainly by the aid of suction/a pressure difference and/or a flow of transporting air, onwards to a separating device (1), in which the waste material to be transported and the transporting air separate from each other, from which separating device the waste material is transferred onwards to a separate waste container (26),
characterized in that waste material is transferred, or is transferred and compressed to become denser, from the separating device (1) into a separate waste container (26) in a connecting channel (9) arranged between them with a transfer member (10), which is moved with a drive device having at least two operating states, from the input aperture (8) of the connecting channel towards the output aperture (9′) and onwards into a separate waste container (26), and in which method the connection from the separating device (1) to the connecting channel (9) is closed at least during the detachment of the waste container (26).

2. Method according to claim 1,
characterized in that the transfer member (10) is moved with a drive device (12, 13, 14, 15, 16), which has at least a first operating state, in which waste material is transferred by moving, with the first drive means (12, 13; 73) of the drive device, the transfer member (10) a part of the distance in the connecting channel (9), at least a second operating state, in which waste material is transferred from the connecting channel (9) into the waste container (26) by moving, moved by the second drive means (15, 16; 74) of the drive device, both the first drive means (12,13, 73) and the transfer member (10), and which has at least a third operating state, in which the connection from the separating device (1) to the connecting channel (9) is closed with the shut-off means (27).

3. Method according to claim 2,
characterized in that the shut-off means (27), preferably an edge (28), is used to cut a detrimental object (30) that is in the connecting channel and causing a blockage or preventing movement of the transfer member.

4. Method according to claim 1,
characterized in that the shut-off means (27) is moved with a second drive means (15, 16).

5. Method according to claim 4, characterized in that the first drive means (12, 13; 73) is connected with a coupling part (18) to a moving part of the second drive means (15, 16; 74) for moving along with it.

6. Method according to claim 1,
characterized in that the shut-off means (27) is brought to be placed against the walls of the chamber (9) in the proximity of the input aperture (8) of the chamber.

7. Method according to claim 1,
characterized in that the drive device is supported on the bottom wall of the connecting channel, e.g. with a support roller (20) that reduces friction.

8. Method according to claim 1,
characterized in that a partial vacuum is maintained in the separating device (1) and/or the separating device is maintained in operation also during the detachment/replacement of a separate waste container (26).

9. Method according to claim 1,
characterized in that the separate waste container (26) is detached from the connection with the connecting channel (9) when the shut-off means (27) is in the closing position.

10. Method according to claim 1,
characterized in that in the method an exhaust air duct (23) is opened when a separate waste container (26) is connected to the connecting channel (9), for achieving a partial vacuum in the connecting channel and/or in the separate waste container after connection of the container.

11. Method according to claim 1,
characterized in that in the method waste material, more particularly household waste material, is transferred from the separating device via the connecting channel into a separate waste container.

12. Method according to claim 1,
characterized in that in the method cylinder-piston units are used as drive means (12, 13; 73; 15, 16; 74), which cylinder-piston units are controlled with control valves (61, 62), with which a differential switch can be selected as one form of use of the drive means.

13. Apparatus for handling material in a pneumatic pipe transport system, which comprises at least one input point, conveying piping and also means for conveying material in the conveying piping, mainly by the aid of suction/a pressure difference and/or a flow of transporting air, into a separating device, where the material to be transported is separated from the transporting air, and also a separate waste container and means (10, 12, 13, 15, 16) for transferring waste material that has accumulated in the separating device (1) from the separating device into the waste container (26),
characterized in that the apparatus comprises a connecting channel (9) arranged between the separating device (1) and a separate waste container (26), in which connecting channel a transfer member (10) and a drive device (12, 13, 14, 15, 16), having at least two operating states, is arranged for moving the transfer member (10) between at least two positions, and in that the apparatus comprises a shut-off means (27) for closing the connection from the separating device (1) to the connecting channel (9) at least during the detachment of the waste container (26).

14. Apparatus according to claim 13,
characterized in that the drive device (12, 13, 14, 15, 16) has a first operating state, in which the transfer member (10) is arranged to be moved with the first drive means (12, 13; 73) of the drive device a part of the distance in the connecting channel (9), a second operating state, in which the second drive means (15, 16; 74) of the drive device is arranged to transfer the first drive means (12,13; 73) and the transfer member (10), and at least one third operating state, in which the shut-off means (27) is arranged to close the connection from the separating device (1) to the connecting channel (9).

15. Apparatus according to claim 13,
characterized in that the shut-off means (27), preferably an edge (28), is configured to function as a cutting means for cutting a detrimental object (30) having an effect in the connecting channel (9).

16. Apparatus according to claim 13,
characterized in that the shut-off means (27) is configured to be moved with a second drive means (15, 16; 74).

17. Apparatus according to claim 13,
characterized in that the first drive means (12, 13; 73) is connected with a coupling part (18) to a moving part of the second drive means (15, 16; 74) for moving along with it.

18. Apparatus according to claim 13,
characterized in that the shut-off means (27) is arranged on the coupling part (18) for moving along with it.

19. Apparatus according to claim 13,
characterized in that the apparatus comprises means for placing the shut-off means (27) against the walls of the connecting channel (9) in the proximity of the input aperture (8) of the connecting channel.

20. Apparatus according to claim 13,
characterized in that a means that reduces friction, e.g. a support roller (20), is arranged on the drive device.

21. Apparatus according to claim 13,
characterized in that an exhaust air duct (23) is arranged in the connecting channel, for achieving a partial vacuum in the connecting channel (9) after connection of the waste container (26).

22. Apparatus according to claim 13,
characterized in that the first drive means (12, 13; 73) and/or the second drive means (15, 16; 74) is a cylinder-piston unit, which cylinder-piston units are controlled with control valves (61, 62), with which a differential switch can be selected as one form of use of the drive means.
